(19) United States
(12) Patent Application Publication
(10) Pub. No.: US 2005/0090420 A1
(43) Pub. Date: Apr. 28, 2005

(54) Method of cleaning white garments with a detergent, bleach and enzyme combination

(76) Inventor: Brian Anthony Aaron, Los Angeles, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/695,296

(22) Filed: Oct. 28, 2003

(51) Int. Cl. C11D 3/00

(52) U.S. Cl. 510/392

(57) ABSTRACT

A method of cleaning white garments comprises the steps of forming a 10% thoroughly mixed aqueous solution containing a detergent, a bleaching agent and an enzyme agent; the detergent is a mixture of sodium citrate, sodium silicate, sodium carbonate, sodium sulfate and a surfactant, the bleaching agent including a mixture of hypochlorite, sodium chloride and sodium hydroxide, and the enzyme agent including sodium perborate monohydrate, STPP, magnesium sulfate and sodium sulfate and agitating the garments in the aqueous solution for not more than one minute and soaking the garments in clear water for between one and ten hours.

### RELATED APPLICATIONS

This application is a Substitute Application for a prior filed application having Ser. No. 10/226,593 and filing date of Aug. 13, 2002 and entitled: Cycle Rinse Laundry Detergent.

### INCORPORATION BY REFERENCE

Applicant(s) hereby incorporate herein by reference, any and all U.S. patents, U.S. patent applications, and other documents and printed matter cited or referred to in this application.

### BACKGROUND OF THE INVENTION

1. Field of the Invention

This invention relates generally to cleaning solutions and methods and more particularly to a new method for effectively cleaning white garments and a formulation of cleaning agents for carrying out the method.

2. Description of Related Art

The following art defines the present state of this field:

Collier, U.S. Pat. No. 3,579,454 describes a detergent composition consisting essentially of an organic synthetic detergent selected from the group consisting of anionic, nonionic, zwitterionic, and ampholytic synthetic detergents and mixtures thereof and an organic or inorganic alkaline builder salt in a weight ratio of from about 10.1 to about 1:30 from about 2.5% to about 60% of an inorganic peroxygen bleaching agent and from about 0.0025% to about 10% of a proteolytic enzyme derived from thermophilic Streptomyces rectus var. proteolytfcus ATCC 21067, said composition being effective in a pH range of 8-12.

Norris, U.S. Pat. No. 3,664,961 describes an enzyme granular detergent composition having improved enzyme stability which comprises at least one water soluble organic synthetic detergent, at least one water soluble detergency builder, an enzyme, and from about 0.005 to 50 percent by weight of a coagglomerated sodium perborate bleaching agent consisting essentially of sodium perborate, a water-soluble polymeric organic agglomerating agent which forms a tacky solution with water at 72° F., and a water-soluble granular coagglomerant.

Kruse et al., U.S. Pat. No. 4,726,908 describes a free-flowing granulate of a powder-form or fine-grained component and a liquid component; the granulate containing at least 20% by weight of the liquid component, is prepared by moving the powder-form or fine-grained component in a mixer-granulator, adding the liquid component while mixing until a moist granulate having a particle size of at most 1.5 mm is obtained, subsequently coarsening the granulate thus obtained with an increase in temperature to a particle size of from 0.4 to 4 mm and optionally coating this coarse granulate with another powder-form and/or fine-grained component at 60 degree to 90 degree. C. The optionally coated granulate is converted by lowering the treatment temperature into a dry-looking, free-flowing, coarse-grained product, which if desired, may be coated with another powder-form and/or fine-grained material. Despite the high percentage of a liquid component, the granulate, thus obtained, appears as a dry granulate and is free-flowing.

Herdeman, U.S. Pat. No. 4,767,557 describes an enzyme and peroxyacid bleach granular composition comprising (1) a homogeneously mixed granulate of enzymes and alkaline buffer salt to protect the enzymes from deactivation when mixed with (2) a strong peroxyacid bleach granulate. This composition can also contain detergent surface-active agents, water-soluble builder salts, and other ingredients commonly used in detergents and laundry additive products.

Clayton et al., U.S. Pat. No. 5,009,804 describes a granular laundry detergent composition comprising two separate surfactant-containing components, optionally together with other dry mixed ingredients. The first component, preferably spray dried, contains a slowly dissolving surfactant in combination with an organic and/or inorganic salt. The surfactant is preferably a long chain (C.sub.16+) alkyl sulfate or a long chain fatty acid salt. The second component comprises one or more surfactants of higher solubility rate and is preferably formed by agglomeration. Satisfactory release of the compositions from the dispensing compartment of an automatic washing machine can be maintained even when the compositions are of a concentrated high-density type.

Yasui et al., U.S. Pat. No. 5,263,650 describes a process for producing a high bulk density granular detergent involving the steps of: (1) milling a solidified detergent material; (2) classifying the milled detergent material obtained in step (1) into fine powders and coarse powders; (3) granulating the fine powders classified in step (2); (4) mixing the granulation product of fine powders obtained in step (3) with the course powders classified in step (2); and (5) surface modifying the mixture obtained in the step (4).

Delwel et al., U.S. Pat. No. 5,356,554 describes a bleach catalyst composition in the form of non-friable composite granules. Each granule is free from easily oxidisable organic materials and comprises a manganese complex catalyst; optionally an inert salt and a binding agent. Detergent compositions comprising such granules have good peroxide and enzyme stability.

Kiesser et al., U.S. Pat. No. 5,739,091 describes an enzyme granule which comprise in their composition, in addition to the enzyme, water-soluble and water-insoluble fillers, binders and if appropriate other granulating auxiliaries, a formate of an alkali metal or alkaline earth metal and if appropriate reducing sugars being added to them to stabilize the enzyme, are described. All the enzymes customary for detergents and cleaning purposes, in particular alkaline proteases, can be processed into the enzyme granules. A process for the preparation of these enzyme granules and their use in pulverulent detergent formulations are also described.

Scepanski, U.S. Pat. No. 5,830,839 describes a detergent composition which is a solid homogeneous, evenly dispersed composition containing anionic and nonionic surfactants, soil suspending agents, chelating or sequestering agents, and alkaline builders. The detergent compositions will contain either active enzymes, an oxygen releasing bleaching agent or both. The active enzymes can be protease, amylase or lipase enzymes. Said composition can be used for laundry washing or hard surface cleaning. Manufacturing procedures and methods of use are described.

Rai et al., U.S. Pat. No. 5,904,161 describes cleaning compositions, particularly automatic dishwashing detergent compositions, comprising a stability-enhanced amylase and bleach-improving materials are provided. More specifically, the invention relates to granular automatic dishwashing detergents, which provide enhanced cleaning/bleaching benefits. The automatic dishwashing compositions comprise stability-enhanced amylase enzymes and one or more bleach-improving compounds, such as organic peroxides, quaternary substituted bleach activators, quaternary substituted peracids and manganese or iron bleach catalysts.

Shanks et al., U.S. Pat. No. 6,022,843 describes an improved, non-phosphate, non-bleach, agglomerated laundry booster which has a) a solids portion with i) at least 5% by weight of a first builder selected from the group consisting of alkali metal carbonate, alkali metal bicarbonate, alkali metal sesquicarbonate, and mixtures thereof; and ii) a second builder of at least 25% by weight alkali metal tetraborate pentahydrate; and b) i) a first liquid which comprises an anionic, acidic surfactant, in an amount no greater than about 10% by weight; and ii) a second liquid which comprises an agglomerating agent. The first liquid is neutralized by the first builder of a) i) to form a first set of particles, the second builder forms a second set of particles, and the second liquid co-agglomerates both the first and second sets of particles. The invention also provides a method for preparing this laundry booster.

Sorrie et al., U.S. Pat. No. 6,046,149 describes a detergent composition containing an amylase enzyme and a builder system comprising an aluminosilicate zeolite, a crystalline layered silicate and most preferably an organic polymeric compound wherein the weight ratio of said crytalline layered silicate to said amylase enzyme (120 KNU/gram activity basis) is from 7:1 to 20:1. In one preferred aspect the detergent composition contains a bleaching system capable of providing delayed release of an organic peroxyacid to a wash solution.

Kuznicki et al., U.S. Pat. No. 6,451,283 describes a zeolitic molecular sieve composition and hybrid zeolite-silica composition that is characterized by novel morphology in which the zeolite is present as macroscopic aggregates of microcrystalline zeolite. The zeolitic compositions of this invention have outstanding capability to complex multivalent cations, especially calcium due to the high exchange kinetics of the microcrystalline zeolite component and yet have the ease of handling due to the macroscopic aggregate assemblage.

Yamashita et al., U.S. Pat. No. 6,521,585 describes detergent formulations incorporating crystalline alkali metal silicate granules providing enhanced performance in removing sebum dirt stains at low dosages of detergent in the wash. The detergent formulations are prepared by combining an alkali metal silicate having a high pH value with a nonionic surfactant and an acid precursor of an anionic surfactant capable of having a lamellar orientation. The formulation is granulated by tumbling in an agitating mixer while increasing the bulk density at elevated temperatures to yield alkali metal silicate granules having a bulk density of from 0.6 to 1.2 g/ml.

Becker et al., U.S. 2002/0147123 describes a particle containing a peroxide-sensitive component (such as an enzyme; e.g., a hydrolase) and an added catalase component. The particle can be included in a detergent composition with peroxygen bleach.

Manske et al., U.S. 2003/0036497 describes disintegration adjunct particles for use in detergents and cleaning agents including an alkali layer silicate and a water swellable compound. The adjunct particles provide increased disintegration of solid particles in detergents and cleaning agents by facilitating the penetration of water into the adjunct particles and hence increase the expansion rate of the water swellable compound. The adjunct particles may also include a readily soluble, non-bleaching active detergent substance to thereby increase the disintegration rate.

Our prior art search with abstracts described above teaches: a dry bleach and stable enzyme granular composition, granular laundry compositions containing multi-ingredient components having disparate rates of solubility, macroscopic aggregates of microcrystalline zeolites, solid detergents with active enzymes and bleach, disintegration adjuncts for use in detergent and cleaning compositions, catalase as an oxidative stabilizer in solid particles and granules, detergent compositions containing an oxidizing bleach and proteolytic enzyme derived from thermophilic streptomyces rectus var. proteolyticus, agglomeration process including a heating step for making a free-flowing granulate, enzyme detergent composition containing co-agglomerated perborate bleaching agent, non-phosphate, agglomerated laundry booster, detergent compositions, cleaning compositions containing bleach and stability-enhanced enzymes, method for producing crystalline alkali metal silicate granules and granular high density detergent, bleach catalyst composition, manufacture and use thereof in detergent and/or bleach compositions, process for producing high bulk density granular detergent, and enzyme granulates, but does not teach a combination detergent, bleach and enzyme treatment in a single dispensing container. The present invention fulfills these needs and provides further related advantages as described in the following summary.

### SUMMARY OF THE INVENTION

The present invention teaches certain benefits in construction and use which give rise to the objectives described below.

The invention includes a formulation for cleaning garments and a method for improved efficiency in so doing. The method of cleaning white garments comprises the steps of forming a 10% thoroughly mixed aqueous solution containing a detergent, a bleaching agent and an enzyme agent; the detergent including a mixture of sodium citrate, sodium silicate, sodium carbonate, sodium sulfate and a surfactant, the bleaching agent including a mixture of hypochlorite, sodium chloride and sodium hydroxide, and the enzyme agent including sodium perborate monohydrate, STPP, magnesium sulfate and sodium sulfate; agitating the garments in the aqueous solution for not more than one minute; and soaking the garments in clear water for between 1 and 10 hours.

A primary objective of the present invention is to provide an apparatus and method of use of such apparatus that provides advantages not taught by the prior art.

Another objective is to provide such an invention capable of cleaning white garments thoroughly.

A further objective is to provide such an invention capable of cleaning with relatively little mechanical agitation.

A still further objective is to provide such an invention capable of cleaning with a large laundry throughput with relatively few chemicals.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

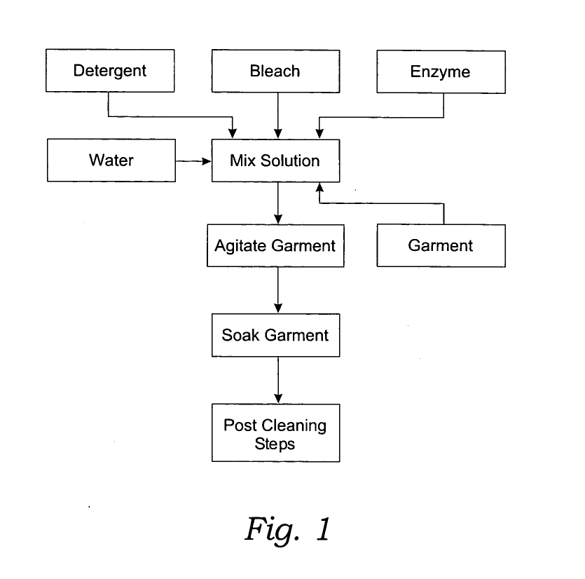

The accompanying drawing illustrates the present invention. In such drawing, FIG. 1 is a block diagram showing the elements of the combination and the method steps used to clean garments.

### DETAILED DESCRIPTION OF THE INVENTION

The above described drawing figures illustrate the invention in at least one of its preferred embodiments, which is further defined in detail in the following description. Those having ordinary skill in the art may be able to make alterations and modifications in the present invention without departing from its spirit and scope. Therefore, it must be understood that the illustrated embodiments have been set forth only for the purposes of example and that they should not be taken as limiting the invention as defined in the following.

The present invention is an agent used for cleaning white garments in a new method. The agent comprises an approximately 10% thoroughly mixed aqueous solution containing a detergent, a bleaching agent and an enzyme agent. The detergent is preferably made up of a mixture of sodium citrate, sodium silicate, sodium carbonate, sodium sulfate and a surfactant. The bleaching agent preferably includes a mixture of hypochlorite, sodium chloride and sodium hydroxide. The enzyme agent preferably includes a mixture of sodium perborate monohydrate, STPP, magnesium sulfate and sodium sulfate. It has been found that the mixture produces significantly improved results when the detergent comprises approximately 68%, the bleaching agent comprises approximately 27%, and the enzyme agent comprises approximately 5% by weight of the mixture of these three agents.

Preferably, the surfactant is added to the solution as a combination of anionic and nonionic surfactants.

The above formulation has been discovered to be critical as to the percentages of each of the three active components and deviation by more than a few percentage points from these portions significantly reduces the effectiveness of the mixture so that it is not able to fulfill the objectives of the invention.

The method of cleaning white garments defined in this invention comprises the steps of forming the 10% thoroughly mixed aqueous solution containing the detergent, the bleaching agent and the enzyme agent and surfactant, and then agitating the garments in the aqueous solution for not more than one minute followed by soaking the garments in clear water for between 1 and 10 hours.

This quick dip into the active cleaning solution followed by a long soaking period in a clear rinse without agitation is considered to be highly novel, provides a great saving in electrical energy and allows a vast improvement in laundry throughput per hour. It also provides a significant improvement in the use of chemicals in that the solution of cleaning agents need only wet the garments and is not therefore “used-up” or depleted quickly. Many garments can be transferred through the cleaning solution as compared with more conventional cleaning methods. Cleaning action is transferred to the soaking cycle, wherein agitation is not desired because such tends to further dilute the cleaning agents which are already soaked into the garment. The purpose of the clear water rinse is to allow the cleaning agents in the garment to move as vectors within an aqueous environment so as to reach all fibers of the garment.

The method further provides the steps of preparing the detergent as a mixture of sodium citrate, sodium silicate, sodium carbonate, sodium sulfate and a surfactant, the bleaching agent as a mixture of hypochlorite, sodium chloride and sodium hydroxide, and the enzyme agent as a mixture of sodium perborate monohydrate, STPP, magnesium sulfate and sodium sulfate. The method further comprises the step of forming the aqueous solution with the detergent comprising approximately 68%, the bleaching agent 27%, and the enzyme agent comprising approximately 5% by weight of the mixture of the three compounds. The compounds used for the three active ingredients are considered to be critical to the effectiveness of the cleaning action and the objectives of this invention.

The method further provides the step of forming the surfactant as a combination of anionic and nonionic surfactants, which has been found to be more effective in causing dirt and stains to leave the garment than either anionic or nonionic surfactants acting alone.

The words used in this specification to describe the invention and its various embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or elements of this described invention and its various embodiments are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the invention and its various embodiments below or that a single element may be substituted for two or more elements in a claim.

Changes from the claimed subject matter as viewed by a person with ordinary skill in the art, now known or later devised, are expressly contemplated as being equivalents within the scope of the invention and its various embodiments. Therefore, obvious substitutions now or later known to one with ordinary skill in the art are defined to be within the scope of the defined elements. The invention and its various embodiments are thus to be understood to include what is specifically illustrated and described above, what is conceptually equivalent, what can be obviously substituted, and also what essentially incorporates the essential idea of the invention.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

1. A method of cleaning white garments comprising the steps of: forming a 10% thoroughly mixed aqueous solution containing a detergent, a bleaching agent and an enzyme agent; the detergent including a mixture of sodium citrate, sodium silicate, sodium carbonate, sodium sulfate and a surfactant, the bleaching agent including a mixture of hypochlorite, sodium chloride and sodium hydroxide, and the enzyme agent including sodium perborate monohydrate, STPP, magnesium sulfate and sodium sulfate; agitating the garments in the aqueous solution for not more than one minute; and soaking the garments in clear water for between 1 and 10 hours.

2. The method of claim 1 further comprising the step of forming the aqueous solution with the detergent comprising approximately 68% by weight of the detergent, bleaching agent and enzyme agent.

3. The method of claim 1 further comprising the step of forming the aqueous solution with the bleaching agent comprising approximately 27% by weight of the detergent, bleaching agent and enzyme agent.

4. The method of claim 1 further comprising the step of forming the aqueous solution with the enzyme agent comprising approximately 5% by weight of the detergent, bleaching agent and enzyme agent.

5. The method of claim 1 further comprising the step of forming the solution with the surfactant as a combination of anionic and nonionic surfactants.

6. An agent for cleaning white garments comprising: a 10% thoroughly mixed aqueous solution containing a detergent, a bleaching agent and an enzyme agent; the detergent including a mixture of sodium citrate, sodium silicate, sodium carbonate, sodium sulfate and a surfactant, the bleaching agent including a mixture of hypochlorite, sodium chloride and sodium hydroxide, and the enzyme agent including sodium perborate monohydrate, STPP, magnesium sulfate and sodium sulfate.

7. The agent of claim 1 wherein the detergent comprises approximately 68% by weight of the detergent, bleaching agent and enzyme agent.

8. The agent of claim 1 wherein the bleaching agent comprises approximately 27% by weight of the detergent, bleaching agent and enzyme agent.

9. The agent of claim 1 wherein the enzyme agent comprises approximately 5% by weight of the detergent, bleaching agent and enzyme agent.

10. The agent of claim 1 wherein the surfactant comprises a combination of anionic and nonionic surfactants.
